(19) United States
(12) Patent Application Publication
(10) Pub. No.: US 2021/0245946 A1
(43) Pub. Date: Aug. 12, 2021

(54) FLEXIBLE POUCH FOR SPARKLING BEVERAGES

(71) Applicant: GUALA PACK S.P.A., Castellazzo Bormida (Alessandria) (IT)

(72) Inventor: Stefano TAMARINDO, Castellazzo Bormida (Alessandria) (IT)

(21) Appl. No.: 17/058,996

(22) PCT Filed: May 17, 2019
(86) PCT No.: PCT/IB2019/054086

§ 371 Date: Nov. 25, 2020

(30) Foreign Application Priority Data
May 25, 2018 (IT) 102018000005725

(51) Int. Cl. B65D 77/06; B65D 75/58; B65D 75/30; B65D 85/72; B32B 27/08; B32B 1/00; B32B 27/36; B32B 27/32; B32B 27/34

(52) U.S. Cl. CPC B65D 77/06; B32B 2250/03; B65D 75/30; B65D 85/72; B32B 27/08; B32B 1/00; B32B 27/36; B32B 27/32; B32B 27/34; B65D 2575/583; B65D 2575/586; B65D 2577/041; B32B 2439/70; B32B 2307/514; B32B 2250/242; B32B 2250/24; B32B 2250/02; B65D 75/5883

(57) ABSTRACT

A flexible pouch for a sparkling beverage includes a flexible, thin-walled outer casing and a flexible, thin-walled inner pouch containing the sparkling beverage. The inner pouch has an inner casing, contained in the outer casing. A closure device is attached to the inner casing. The outer casing is closed so that the inner casing is concealed from view, while the closure device remains outside the outer casing.

### CROSS-REFERENCE TO RELATED APPLICATIONS

This application is a National Stage Application of International Patent Application No. PCT/IB2019/054086, having an International Filing Date of May 17, 2019, which claims the benefit of priority to Italian Patent Application No. 102018000005725, filed May 25, 2018, the entire contents of which are hereby incorporated by reference herein.

### FIELD OF THE INVENTION

The object of the present invention is a flexible pouch for sparkling beverages and, in particular, a flexible pouch provided with a spout.

### BACKGROUND OF THE INVENTION

Thin-walled flexible pouches with spout, usually referred to as “spouted pouches” in the packaging industry, are becoming increasingly popular, especially for packaging products for children or sports, such as fruit juices, yoghurt, fruit puree, energy drinks and the like.

Their popularity is due to a number of factors, such as convenience in use on the part of the consumer, but also convenience and ease of transport on the part of the manufacturer.

However, pouches are little or not at all used in the sector of sparkling beverages, as the carbon dioxide contained in such beverages, which normally tends to separate from the liquid phase, causes a swelling of the pouch.

In the eyes of the consumer, said swelling is not associated with a normal process of separation of the gaseous phase from the liquid phase, but rather with a state of deterioration of the product, for example due to poor conservation.

### SUMMARY OF THE INVENTION

Therefore, the object of the present invention is to create a flexible pouch particularly suitable for containment of sparkling beverages, able to satisfy the needs of the sector and overcome the drawbacks mentioned above.

Such object is achieved by a flexible pouch comprising a flexible, thin-walled outer casing and an inner pouch containing a sparkling beverage, wherein the inner pouch comprises an inner casing and a closure device applied to the inner casing, said inner casing being contained in the outer casing, closed so that the inner casing is concealed from view, while said closure device remains outside the outer casing.

Advantageous embodiments of the invention are also described.

### BRIEF DESCRIPTION OF THE DRAWINGS

The features and advantages of the flexible pouch according to the present invention will be apparent from the description given below, provided by way of non-limiting example, according to the accompanying figures, wherein:

FIGS. 1a, 1b and 1c illustrate a flexible pouch according to the present invention, in separate parts;

FIGS. 2 and 3 and their respective enlargements A and B illustrate the flexible pouch according to the present invention, in accordance with an initial embodiment; and

FIGS. 4 and 5 and their respective enlargements C and D illustrate the flexible pouch according to the present invention, in accordance with a further embodiment.

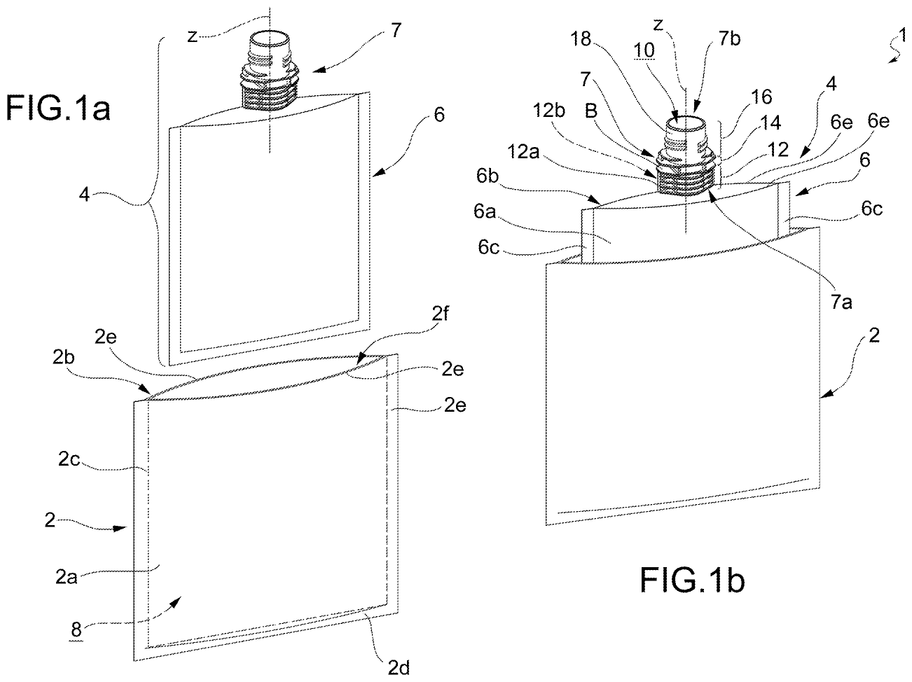

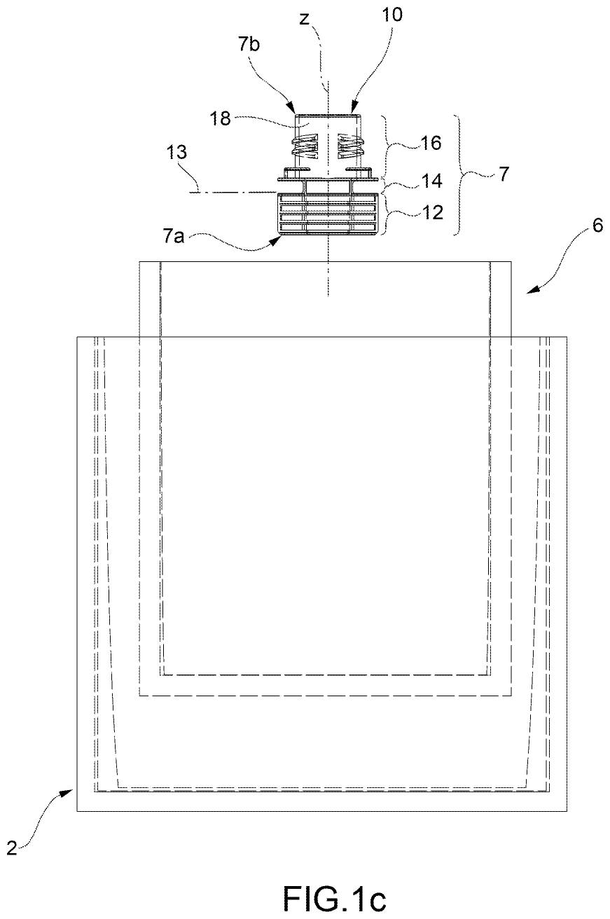

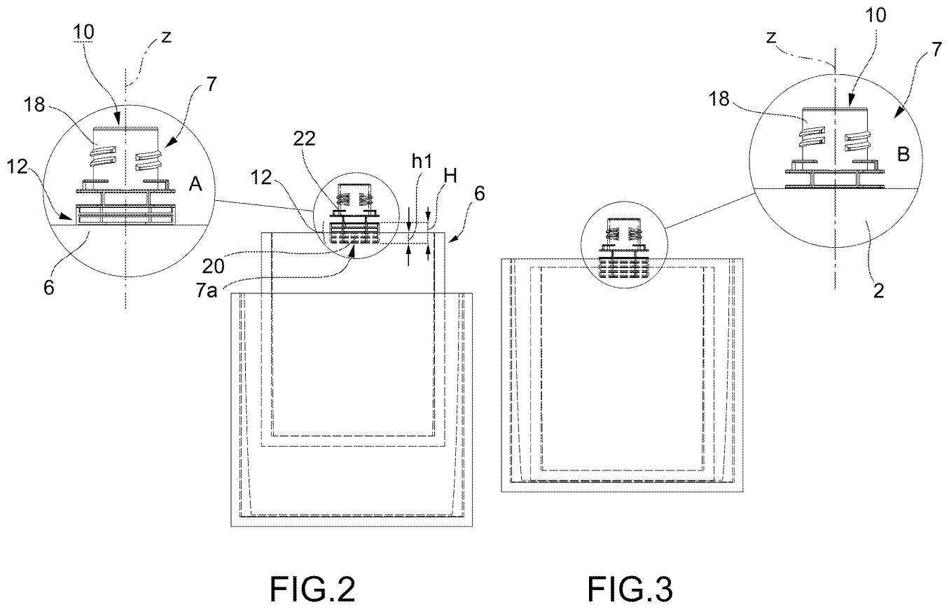

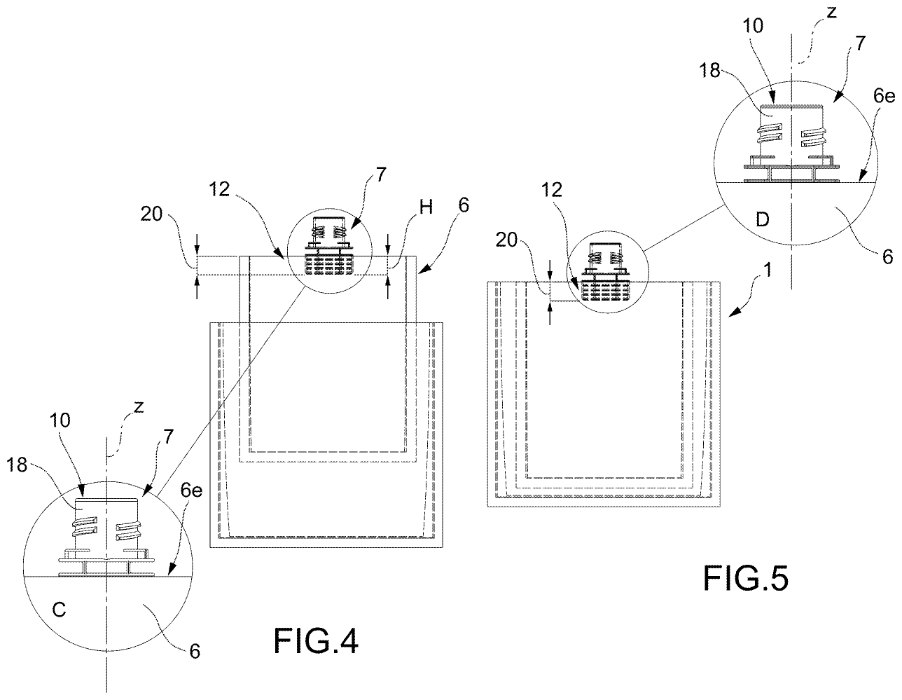

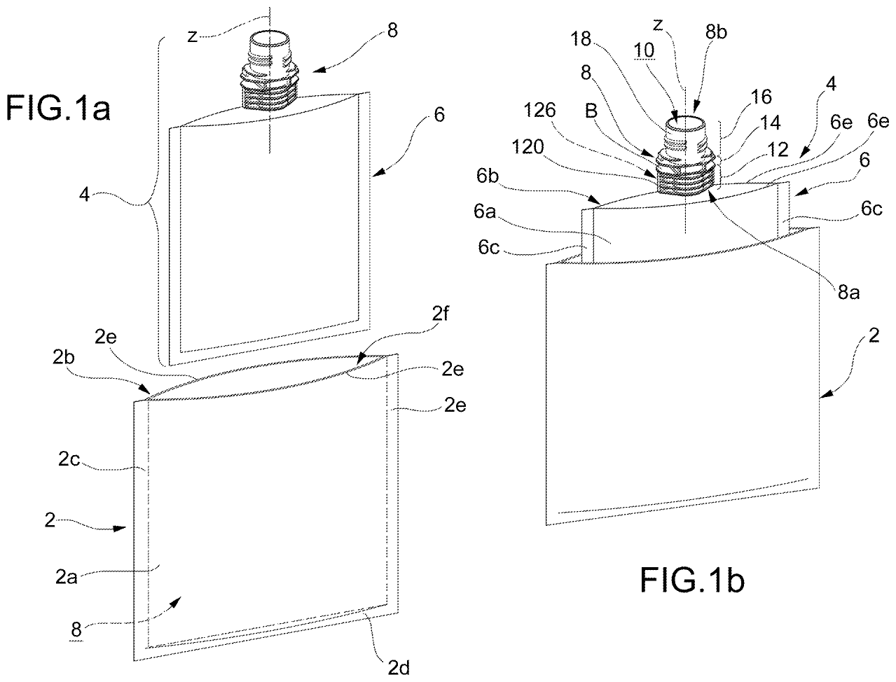

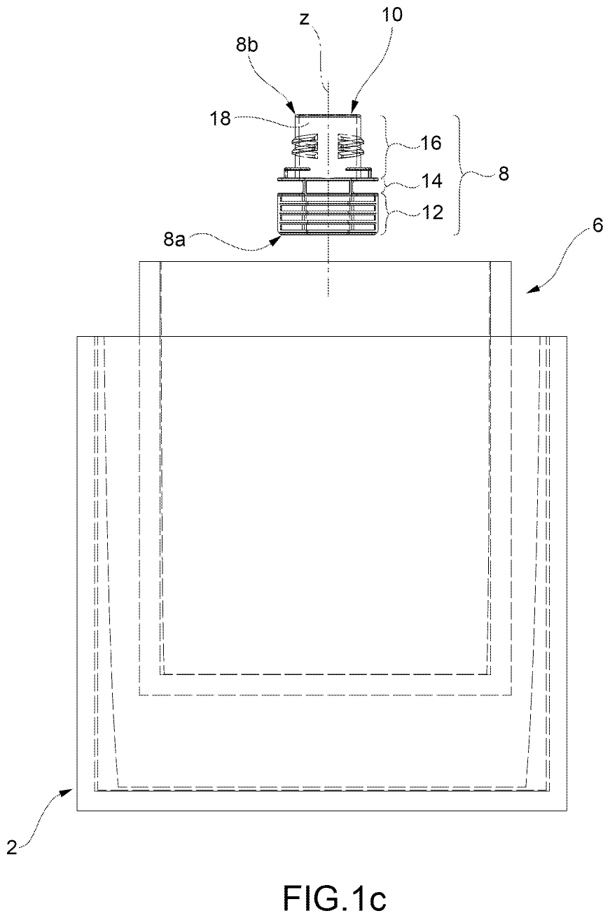

### DETAILED DESCRIPTION

With reference to the accompanying figures, a flexible pouch 1 according to the present invention comprises a flexible, thin-walled outer casing 2 and an inner pouch 4.

The inner pouch 4, consisting of a flexible, thin-walled pouch, is designed to contain the sparkling beverage and comprises an inner casing 6 and a closure device 7. The inner casing 6 is contained in the outer casing 2, so as to be concealed from view.

The outer casing 2 comprises outer front walls 2a, 2b, placed facing each other, made from a preferably multilayer film.

Depending on the embodiment, the outer front walls 2a, 2b are welded along their respective side edges 2c and along a lower edge 2d, while the upper edges 2e are initially separated to form an opening 2f for insertion of the inner casing 6.

According to a further embodiment (not shown), the outer casing also comprises side walls and/or a bottom, also made from a flexible, preferably multilayer, film.

The outer casing 2 has an inner compartment 8 for housing the inner casing 6.

In particular, in order to conceal the swelling of the inner casing 6 due to the separation of the gaseous phase from the liquid phase, the inner compartment 8 of the outer casing 2 is larger than the inner casing 6. This allows the outer casing 2 to be free of swelling (and maintain the typical crumpled appearance) even when the inner casing 6 is swollen.

In particular, the inner compartment 8 has a transverse dimension, i.e. between the side edges 2c, greater than the transverse size of the inner casing 6.

The film composing the outer casing is multilayer and comprises, from the inside outwards, PET/PE or PET/PP or OPP/PE or OPP/PP.

The outer layer has a thickness between 30 and 120 micrometers and the inner layer has a thickness ranging from 10 to 40 micrometers.

The inner casing 6 comprises inner front walls 6a, 6b, placed facing each other, preferably made from a multilayer film.

Depending on the embodiment, the inner front walls 6a, 6b are welded along their respective side edges 6c and along a lower edge, while the upper edges 6e are preferably welded together and, at least for a portion, to the closure device 7.

According to a further embodiment (not represented), the inner casing also comprises side walls and/or a bottom, also made from a flexible film, preferably multilayer.

The film composing the inner casing is multilayer and comprises, from the inside outwards, PE/OPA/PP or PP/OPA/PP or PE/OPP or OPP/OPP/PP.

The outer layer has a thickness between 30 and 120 micrometers, while the inner layer has a thickness ranging from 10 to 25 micrometers.

The closure device 7 is a spout device that extends along a main axis Z between an inner end 7a and an opposite outer end 7b, penetrated by a delivery conduit, ending at the outer end 7b with a mouth 10 for the outflow of the beverage.

From the inner end 7a to the outer end 7b, the spout device comprises a connecting portion 12 having a predefined axial dimension H along the main axis Z, preferably an intermediate portion 14, and an end portion 16.

The connecting portion 12, preferably axially separated from the intermediate portion 14 or from the end portion 16 by an end plane 13 orthogonal to the main axis Z, has two faces 12a, 12b facing with respect to an imaginary plane containing the main axis Z, preferably corrugated so as to be joined to the transverse ends.

Said faces 12a, 12b form the so-called “welding boat”.

The end portion 16 consists of a tube 18 ending with the mouth 10, preferably threaded externally for screwing on a cap of the closure device.

The connecting portion 12 is intended to be welded to the upper edges 6e of the inner casing 6, to obtain a sealed inner pouch 4.

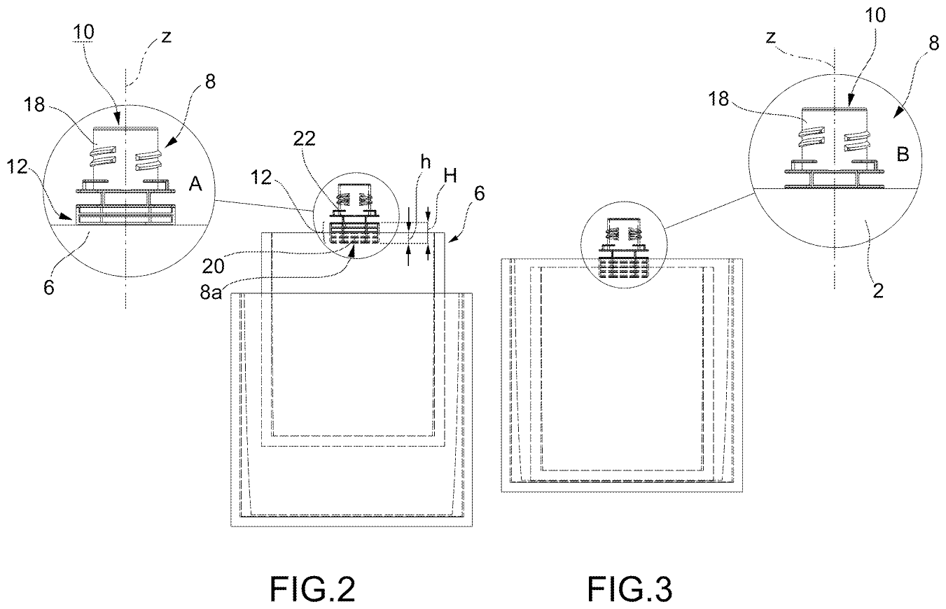

According to an initial embodiment (FIGS. 2 and 3), the upper edges 6e of the inner casing 6 overlap axially the connecting portion 12 of the spout device only for a portion of the axial dimension H of said connecting portion 12.

In other words, the upper edges 6e of the inner casing 6 overlap axially the connecting portion 12 only for an overlapping portion 20 of dimension h1, where h1<H; said upper edges 6e are also welded to the connecting portion 12 within said overlapping portion 20 or over the whole overlapping portion 20.

Preferably, the overlapping portion 20 is proximal to the inner end 7a with respect to the residual portion 22 which remains uncovered by the upper edges 6e of the inner casing 6.

In other words, according to said embodiment, the residual portion 22 remains outside the inner casing 6.

The upper edges 2e of the outer casing 2 are welded together and, at the spout device, overlap the residual portion 22 of the connecting section 12.

In particular, the upper edges 2e may be welded to the connecting portion 12 only within the residual portion 22 or only for the entire residual portion 22.

According to a variant embodiment, the upper edges 2e are welded to the connecting portion 12 within the residual portion 22 or for the entire residual portion 22, and within the overlapping portion 20 or for the entire overlapping portion 20 overlapping the upper edges 6e of the inner casing 6.

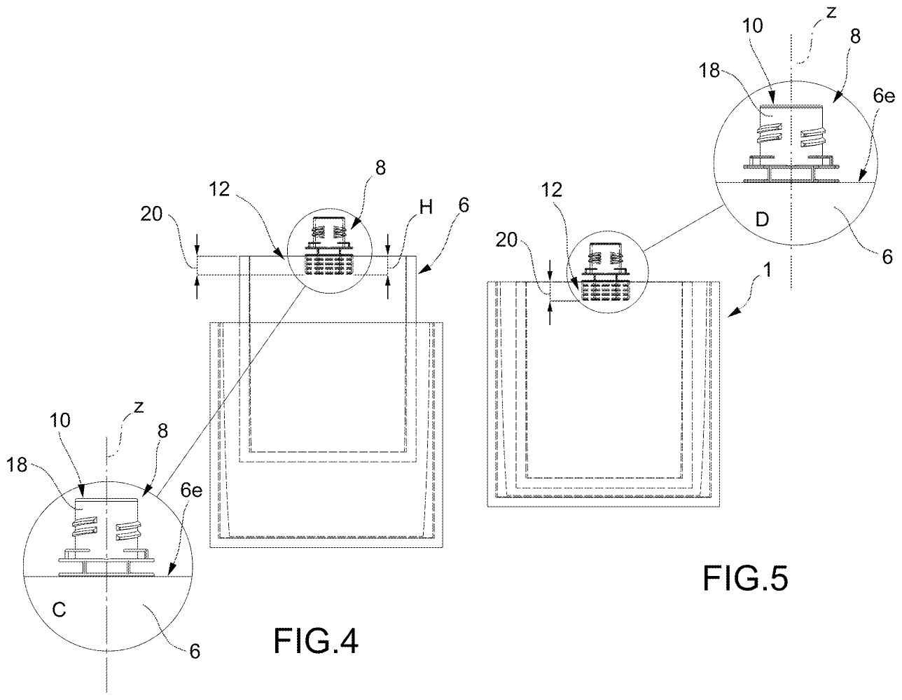

According to a further embodiment (FIGS. 4 and 5), the upper edges 6e of the inner casing 6 overlap axially the connecting portion 12 of the spout device for the entire axial dimension H of said connecting portion 12.

In other words, the upper edges 6e of the inner casing 6 overlap axially the connecting portion 12, totally covering it; said upper edges 6e are also welded to the connecting portion 12 within said overlapping portion 20 or over the whole overlapping portion 20.

The upper edges 2e of the outer casing 2 are welded together and, at the spout device, overlap the connecting portion 12 thereof, for the entire axial dimension H thereof.

In particular, the upper edges 2e are welded to the connecting portion 12 for all or part of the axial dimension H.

Innovatively, the flexible pouch according to the present invention overcomes the drawbacks mentioned with reference to the prior art, because the swelling of the inner casing, due to the separation of the gas phase from the liquid phase of the beverage, is not visible from the outside, since the outer casing, within which the inner casing is contained, is larger than the inner casing.

It is apparent that one skilled in the art, in order to meet contingent needs, may make changes to the flexible pouch described above, without departing from the scope of protection as described and claimed herein.

1. A flexible pouch for a sparkling beverage, comprising a thin-walled, flexible outer casing, and an inner pouch containing the sparkling beverage, wherein the inner pouch comprises an inner casing and a closure device applied to the inner casing, said inner casing being contained in the thin-walled, flexible outer casing, said thin-walled, flexible outer casing being closed so that the inner casing is concealed from view, while said closure device remains outside the thin-walled, flexible outer casing.

2. The flexible pouch of claim 1, wherein the thin-walled, flexible outer casing has an inner compartment, having dimensions larger than the dimensions of the inner casing.

3. The flexible pouch of claim 2, wherein the inner compartment has a transverse dimension between side edges of outer front walls of the thin-walled, flexible outer casing greater than the transverse dimension of the inner casing.

4. The flexible pouch of claim 1, wherein the closure device is a spout device extending along a main axis (Z) between an inner end and an opposite outer end, penetrated by a delivery duct, terminating at the outer end with a mouth for outflow of the sparkling beverage, comprising, from the inner end towards the outer end, a connecting portion, having a predefined axial dimension (H) along the main axis (Z), and an end portion consisting of having a tube terminating with said mouth, to which a cap of the closure device may be attached is attachable.

5. The flexible pouch of claim 4, wherein the connecting portion is at least partially welded to upper edges of the inner casing so that said inner pouch is sealed.

6. The flexible pouch of claim 5, wherein the upper edges of the inner casing axially overlap the connecting portion of the spout device only for an overlapping portion of the predefined axial dimension (H) of said connecting portion, leaving a residual uncovered.

7. The flexible pouch of claim 6, wherein the upper edges are welded to the connecting portion within said overlapping portion or over the entire overlapping portion.

8. The flexible pouch of claim 6, wherein the overlapping portion is near the inner end of the spout device with respect to the residual portion.

9. The flexible pouch of 6, wherein the upper edges of the thin-walled, flexible outer casing are welded together and axially overlap the residual portion at the spout device.

10. The flexible pouch of claim 9, wherein the upper edges are welded to the connecting portion only within the residual portion or only for the entire residual portion.

11. The flexible pouch of claim 9, wherein the upper edges are welded to the connecting portion within the residual portion or for the entire residual portion, and within the overlapping portion or for the entire overlapping portion by welding at the upper edges of the inner casing.

12. The flexible pouch of claim 5, wherein the upper edges of the inner casing axially overlap the connecting portion of the spout device throughout the predefined axial dimension (H) of said connecting portion.

13. The flexible pouch of claim 12, wherein the upper edges are welded to the connecting portion for the entire extension thereof or only partially.

14. The flexible pouch of claim 12, wherein the upper edges of the thin-walled, flexible outer casing are welded together and, at the spout device, overlap the connecting portion, for the entire axial dimension (H) thereof.

15. The flexible pouch of claim 14, wherein the upper edges are welded to the connecting portion for the entire extension thereof or only partially, overlapping the upper edges of the inner casing.

16. The flexible pouch of claim 1, wherein the film composing the thin-walled, flexible outer casing is multilayer and comprises, from the inside outwards, polyethylene terephthalate/polyethylene (PET/PE) or polyethylene terephthalate/polypropylene (PET/PP) or oriented polypropylene/polyethylene (OPP/PE) or oriented polypropylene/polypropylene (OPP/PP).

17. The flexible pouch of claim 16, wherein an outer layer of the film of the thin-walled, flexible outer casing has a thickness between 30 and 120 micrometers, while an inner layer has a thickness ranging from 10 to 40 micrometers.

18. The flexible pouch of claim 1, wherein the film composing the inner casing is multilayer and comprises, from the inside outwards, polyethylene/oriented polyamide/polypropylene (PE/OPA/PP) or polypropylene/oriented polyamide/polypropylene (PP/OPA/PP) or polyethylene/oriented polypropylene (PE/OPP) or oriented polypropylene/oriented polypropylene/polypropylene (OPP/OPP/PP).

19. The flexible pouch of claim 18, wherein an outer layer of the film of the inner casing has a thickness between 30 and 120 micrometers, while an inner layer has a thickness ranging from 10 to 25 micrometers.

20. The flexible pouch of claim 1, wherein the inner pouch is a thin-walled, flexible pouch.
